(19) United States
(12) Patent Application Publication
(10) Pub. No.: US 2023/0388438 A1
(43) Pub. Date: Nov. 30, 2023

(54) DISPLAY DEVICE, DISPLAY CONTROL METHOD, AND NON-TRANSITORY RECORDING MEDIUM

(71) Applicant: SHARP KABUSHIKI KAISHA, Sakai City (JP)

(72) Inventor: YUICHI YOSHIDA, Sakai City (JP)

(21) Appl. No.: 18/201,772

(22) Filed: May 25, 2023

(30) Foreign Application Priority Data
May 27, 2022 (JP) 2022-086468

(51) Int. Cl. H04N 5/14; H04N 5/445; H04N 5/60; H04N 5/50; H04N 5/765

(52) U.S. Cl. CPC H04N 5/147; H04N 5/44504; H04N 5/602; H04N 5/50; H04N 5/765

(57) ABSTRACT

A display device includes a receiver that receives at least video data and genre information, an acquirer that acquires image quality information corresponding to the genre information, a genre detector that detects a change in the genre information, a scene detector that detects a scene change of the video data, and a controller that performs, when a change in the genre information is detected, control such that image quality of the video data is set based on image quality information corresponding to the changed genre information after the change is detected and after the scene change is detected.

### BACKGROUND OF THE INVENTION

### Field of the Invention

The present disclosure relates to a display device, a display control method, and a recording medium.

### Description of the Background Art

A technique of detecting a genre of a program being displayed on a television receiver and causing the television receiver to perform a type of brightness processing memorized in association with the detected genre is known.

In general, in multiplexed broadcast waves, video data and genre information of a program are not synchronized with each other. Furthermore, when a program is switched, the genre information is transmitted before a time point at which the program is switched. Therefore, before the video data of the program is switched, the television receiver detects the switching of the genre information.

When the television receiver performs image processing with an image quality setting (such as a brightness setting) based on genre information of a program after switching at a time when the switching of the genre information is detected, appropriate image processing is not performed. In other words, even though video data obtained before the program is switched is displayed by the television receiver, the image processing is performed on video data with an image quality setting for a next program. In this case, image quality of the displayed image is degraded because the image processing with an appropriate image quality setting is not performed. The general techniques do not solve such a problem.

As one aspect, an object of the present disclosure is to provide a display device or the like that is capable of suppressing degradation of image quality when performing image processing based on genre information.

### SUMMARY OF THE INVENTION

According to an aspect of the present disclosure, a display device includes a receiver that receives at least video data and genre information, an acquirer that acquires image quality information corresponding to the genre information, a genre detector that detects a change in the genre information, a scene detector that detects a scene change of the video data, and a controller that performs, when a change in the genre information is detected, control such that image quality of the video data is set based on image quality information corresponding to the changed genre information after the change is detected and after the scene change is detected.

### BRIEF DESCRIPTION OF THE DRAWINGS

FIG. 1 is a diagram illustrating an example of a television receiver according to a first embodiment.

FIG. 2 is a table of an example of the correspondence relationships between genres and image quality parameters.

FIG. 3A is a diagram illustrating an example of a general change in an image quality setting.

FIG. 3B is a diagram illustrating an example of a change in an image quality setting to which the first embodiment is applied.

FIG. 4 is a diagram illustrating an example of a scene change detection.

FIG. 5 is a flowchart of an example of a process according to the first embodiment.

FIG. 6A is a diagram illustrating an example of a change in an image quality setting to which a second embodiment is applied.

FIG. 6B is a diagram illustrating another example of the change in an image quality setting to which the second embodiment is applied.

FIG. 7 is a flowchart of an example of a process according to the second embodiment.

FIG. 8 is a diagram illustrating an example of a change in an image quality setting to which a third embodiment is applied.

FIG. 9 is a flowchart of an example of a process according to the third embodiment.

FIG. 10 is a diagram illustrating an example of a change in an image quality setting to which a fourth embodiment is applied.

FIG. 11 is a diagram illustrating an example of a television receiver according to a sixth embodiment.

### DESCRIPTION OF THE PREFERRED EMBODIMENTS

### First Embodiment

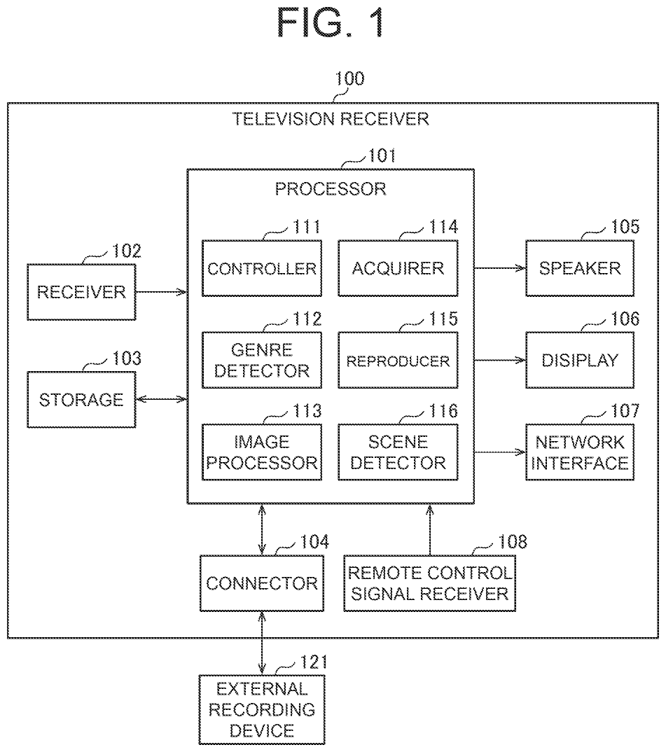

A first embodiment will be described hereinafter. FIG. 1 is a diagram illustrating an example of a television receiver 100 according to a first embodiment. The television receiver 100 (a display device) includes a processor 101, a receiver 102, a storage 103, a connector 104, a speaker 105, a display 106, a network interface 107, and a remote control signal receiver 108. The television receiver 100 may have other components, or some of the components in FIG. 1 may be omitted.

The processor 101 includes a controller 111, a genre detector 112, an image processor 113, an acquirer 114, a reproducer 115, and a scene detector 116. The processor 101 is a computer that executes various processes of various embodiments. The processor 101 includes a processor device and a memory. When the processor device of the processor 101 executes a plurality of instruction sets (programs) stored in the memory, various types of control of the embodiments may be realized. As the processor device, any processor device may be used, such as a CPU (Central Processing Unit), a GPU (Graphics Processing Unit), or an FPGA (Field Programmable Gate Array).

The programs described above are stored in a non-transitory recording medium, such as a semiconductor medium, an optical recording medium, or a magneto-optical recording medium. When the processor device of the processor 101 executes the programs stored in the recording medium, various types of control of the embodiments may be realized. The programs described above may also be obtained by the television receiver 100 from an external server through a network.

The receiver 102 includes, for example, a tuner. The receiver 102 receives broadcast waves delivered by broadcasting apparatuses of one or more broadcasters and performs prescribed signal processing. Such broadcast waves may include a plurality of programs distributed by the broadcasters. The receiver 102 receives broadcast waves in a wireless or wired manner. Furthermore, the broadcast waves are transmitted in terrestrial broadcasting (terrestrial digital television broadcasting) and satellite broadcasting. Examples of the satellite broadcasting include BS (Broadcasting Satellites) broadcasting, CS (Communication Satellites) broadcasting, and the new 4K8K satellite broadcasting.

The storage 103 stores various types of information. The storage 103 stores, for example, image quality parameters as image quality information associated with an image quality setting suitable for a video being displayed on the display 106. The storage 103 may store other information.

The connector 104 is connected to an external recording device 121. The external recording device 121 is a recording device that records data (program data) of a program received by the television receiver 100. The external recording device 121 is a USB (Universal Serial Bus) hard disk, a recorder, or the like.

The processor 101 can record program data received by the receiver 102 in the external recording device 121 via the connector 104. Furthermore, the processor 101 reads program data (recording data) recorded in the external recording device 121 via the connector 104 and reproduces the read program data. The external recording device 121 may be a recording device incorporated in the television receiver 100, for example.

The speaker 105 is a device that outputs audio. The display 106 is a device that displays images. Video of a program received by the receiver 102 is displayed on the display 106, and audio corresponding to the video is output from the speaker 105. The same applies when program data recorded in the external recording device 121 is reproduced.

The network interface 107 is connected to an external server via the Internet. The television receiver 100 can retrieve moving image data, for example, from the external server. The details will be described later.

The remote control signal receiver 108 receives a signal supplied from a remote controller used to operate the television receiver 100. The remote control signal receiver 108 outputs the received signal to the processor 101.

The controller 111 of the processor 101 performs various types of control in the embodiments. The genre detector 112 detects genre information and detects a change in genre information when the genre information is changed. The genre information will be described later in detail. The image processor 113 performs image processing on video data using an image quality setting (an image quality parameter) suitable for a video displayed on the display 106.

The acquirer 114 acquires from the storage 103 the image quality parameter suitable for the video displayed on the display 106. The reproducer 115 reads program data recorded in the external recording device 121 and reproduces the read program data.

The scene detector 116 detects scene changes in a program. A program includes a plurality of scenes, and the scene detector 116 detects scene changes in the program based on changes in consecutive scenes among the plurality of scenes.

Video data and genre information are multiplexed with each other in information about a program of a broadcast wave received by the receiver 102. The genre information indicates a genre of a program. Examples of the genre include sports, news, and drama.

The image processor 113 performs image processing on video data using image quality parameters of an image quality setting according to the video data of the program. The image quality parameters for suitable image processing vary depending on a program genre. For example, optimal image quality parameters when the genre is sports are different from optimal image quality parameters when the genre is news. However, the same image quality parameters may be used for different genres.

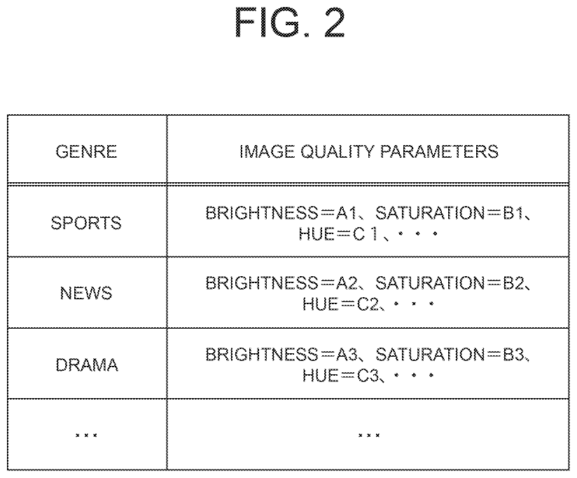

FIG. 2 is a table of an example of the correspondence relationships between genres and image quality parameters. For example, in the example in FIG. 2, when a genre is sports, image quality parameters used for image processing on video data are A1 for brightness, B1 for saturation, and Cl for hue.

When a genre corresponding to a video displayed on the display 106 is sports, the acquirer 114 reads the table example in FIG. 2 stored in the storage 103 to acquire the image quality parameters corresponding to the genre of sports. The image processor 113 performs image processing on video data using the acquired image quality parameters.

The same applies when a genre is news and when a genre is drama. The acquirer 114 acquires the image quality parameters corresponding to the genre information, and the image processor 113 performs the image processing on the video data using the acquired image quality parameters, so that a suitable image for the genre is displayed on the display 106.

Examples of genres and image quality parameters are not limited to the examples in FIG. 2. Movies, for example, may be employed as a genre. For example, contrast, sharpness, noise reduction, and the like may be employed as the image quality parameters.

A case where a program of the broadcast wave is switched will now be described. Video data and genre information of a program multiplexed into a broadcast wave received by the receiver 102 is not synchronized with each other. In addition, the genre information is transmitted in advance of the video data in the broadcast wave.

The genre detector 112 detects a genre of the program based on the genre information multiplexed in the broadcast wave received by the receiver 102. As described above, the genre information is transmitted in advance of the video data. Therefore, when switching between programs of different genres is performed, the genre detector 112 detects the change in program genre at a time before the video data is switched.

General television receivers change image quality parameters for image processing to be performed on video data at a timing when a change in genre is detected. In this case, even though a video displayed on the television receiver is from the previous program, video data of the video is subjected to the image processing using the image quality parameters of the next program. In this case, optimal image quality may not be attained due to the image processing using the image quality parameters that are not appropriate for the video data.

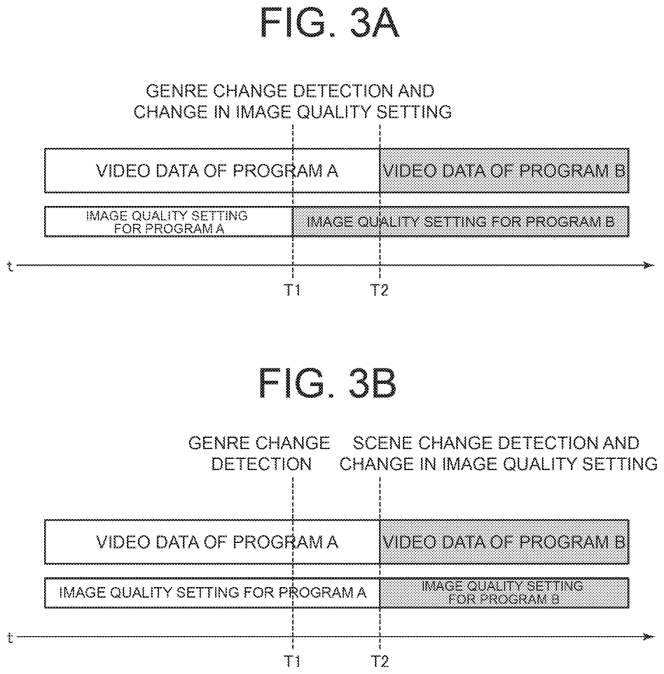

FIG. 3A is a diagram illustrating an example of a general change in an image quality setting. Prior to a time point T1, a television receiver receives video data and genre information for a program A. It is assumed that a genre of the program A is sports and a genre of a program B is news.

At the time point T1 that comes before a time point T2 when the television receiver switches the video data of the program A to video data of the program B, the genre information received by the television receiver is switched from the genre information of the program A to genre information of the program B. As a result, the television receiver detects the change in genre information at the time point T1.

In the general television receiver, at the time point T1 when the change in genre information is detected, image quality parameters for image processing to be performed on the video data are changed from those for the program A to those for the program B.

In this case, even though a video displayed on the television receiver is of the program A, video data of the video is subjected to the image processing using the image quality parameters of the program B. In the example above, even though a video displayed in a period of time from the time point T1 to the time point T2 is of a program of the sports, video data of the sports program is subjected to the image processing using the image quality parameters for the news.

Therefore, in a period of time from the time point T1 to the time point T2, the video data is not subjected to optimal image processing, and the video displayed on the television receiver is not of optimal quality. This causes a user watching TV to feel uncomfortable with the image quality in the period of time from the time point T1 to the time point T2. As a result, the image quality is degraded in the period of time from the time point T1 to the time point T2.

FIG. 3B is a diagram illustrating an example of a change in an image quality setting to which the first embodiment is applied. Prior to a time point T1, the receiver 102 receives video data and genre information for a program A, and the display 106 displays the video data subjected to image processing using image quality parameters for the program A. At the time point T1, the genre information received by the receiver 102 is switched from genre information of the program A to that of a program B.

The genre detector 112 detects that the genre information has been changed at the time point T1. In this embodiment, the controller 111 does not change image quality parameters to be employed in the image processor 113 at a time when the change in genre information is detected, but performs control such that the image quality parameters being applied to the program A is maintained.

The controller 111 changes the image quality parameters to be applied to the image processor 113 to the image quality parameters for the program B after the genre detector 112 detects a change in genre information and after the scene detector 116 detects a scene change.

Accordingly, a timing at which the image quality parameters for the image processing to be performed on the video data are changed when the genre information received by the receiver 102 of the television receiver 100 is changed may coincide with a timing at which the video data of the program is switched.

In the case of the example in FIG. 3B, in a period of time from the time point T1 to a time point T2, the controller 111 maintains the image quality parameters of the image processing performed by the image processor 113 at the image quality parameters for the program A, even though the genre detector 112 detects a change in genre. Note that, as described below, image quality parameters employed in a single program may vary depending on a scene. Scene-specific details are described below.

When the genre of the program A is sports and the genre of the program B is news, in a period from the time point T1 to the time point T2, under the control of the controller 111, the image processor 113 performs the image processing on the video data of the sports program using the image quality parameters for sports. Accordingly, degradation of image quality of the video displayed on the display 106 is suppressed.

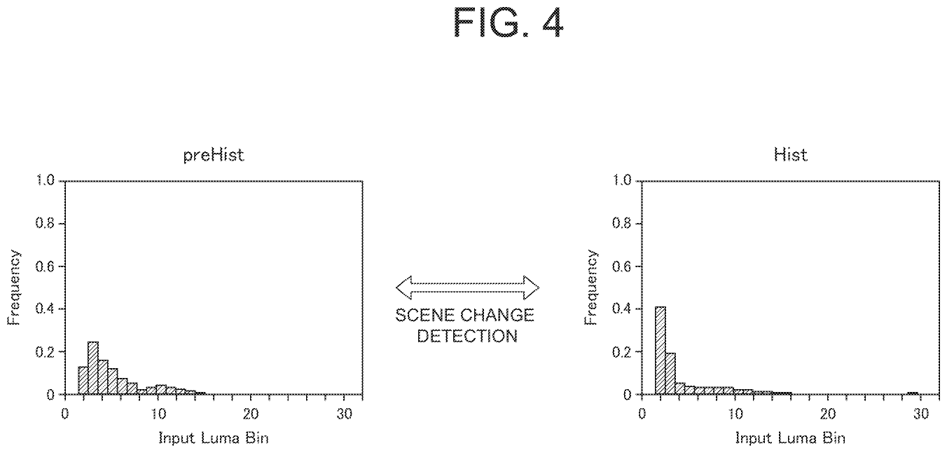

The scene changes detected by the scene detector 116 will now be described. FIG. 4 is a diagram illustrating an example of a scene change detection. The example in FIG. 4 shows two consecutive scenes of video data. Here, “preHist” represents a histogram of brightness of video data before a scene change. Furthermore, “Hist” represents a histogram of brightness of video data after the scene change. Axes of abscissae of the histograms represent brightness, and axes of ordinates represent frequency of occurrence.

The scene detector 116 detects whether a scene change has occurred based on whether an amount of change between the brightness histograms of the consecutive scenes is greater than a predetermined amount for each scene of the video data. For example, the controller 111 detects a scene change when a sum of differences between absolute values or difference squared values of individual bins in the brightness histograms of the successive scenes is equal to or greater than a predetermined threshold value.

In the example in FIG. 4, difference values of a number of the bins in low brightness between the video data of “preHist” and the video data of “Hist” are large. It is assumed that the values of the differences in absolute values between bins of the video data of “preHist” and bins of the video data of “Hist” are equal to or greater than a threshold value. In this case, the scene detector 116 detects a scene change between the video data of “preHist” and the video data of “Hist”. The above threshold values may be arbitrarily set.

The scene detector 116 may detect a scene change using a method other than that using the brightness histograms described above. For example, the video data may be accompanied by metadata indicating brightness of a video signal for each scene. The metadata is, for example, dynamic metadata specified in HDR (High Dynamic Range). The dynamic metadata includes, for example, information on maximum brightness of the video signal for each scene.

The scene detector 116 may detect a scene change based on the metadata. For example, the scene detector 116 may detect a scene change when an amount of change in brightness between video signals indicated by dynamic metadata of two successive scenes is equal to or greater than the threshold value described above.

Alternatively, the scene detector 116 may detect a scene change based on a change in audio data corresponding to the video data. For example, in a case where a commercial (CM) is inserted between the program A and the program B, the scene detector 116 may detect a scene change when the CM is detected.

It is assumed that the CM has stereo audio and the program has mono audio or dual audio. The scene detector 116 may detect a scene change when detecting switching of the audio data corresponding to the video data from the mono or dual audio to the stereo audio.

Furthermore, at a juncture of switching from the program to the CM, audio data of a broadcast wave is often silent, albeit for a short period of time. The scene detector 116 may detect a scene change when the audio data becomes silent.

A base volume of the audio data of the program is different from that of the CM. The scene detector 116 may detect a scene change when an amount of a change in audio data is equal to or greater than a predetermined change amount. The method of detecting a scene change based on a change in audio data may be applied not only to a changeover from a program to a CM but also to the changeover from the program A to the program B, for example. Alternatively, the scene detector 116 may detect a scene change based on presence or absence of a logo mark representing a broadcaster. Program data of a program of a broadcast includes a logo mark representing a broadcaster. On the other hand, the CM does not include such a logo mark. The scene detector 116 may detect a scene change when no longer detecting such a logo mark.

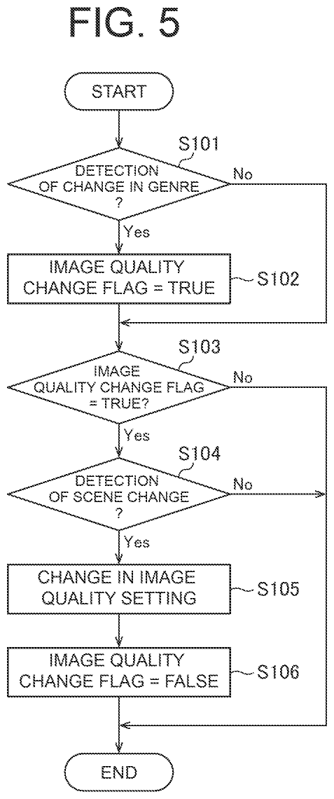

FIG. 5 is a flowchart of an example of the process according to the first embodiment. The flowchart in FIG. 5 is continuously executed while video data of a program of a broadcast wave received by the receiver 102 is displayed on the display 106.

The controller 111 determines whether the genre detector 112 has detected a change in genre information received by the receiver 102 (step S101). When the genre detector 112 has not detected the change in genre information, the controller 111 obtains a negative determination result in step S101 and proceeds to step S103. Note that, before the process in step S101 is executed, an image quality change flag described below is set to False.

When the genre detector 112 has detected a change in genre information, the controller 111 obtains a positive determination result in step S101 and proceeds to step S102. The controller 111 sets the image quality change flag to True (step S102).

The image quality change flag indicates that the image quality parameters applied to the image processor 113 are to be changed. The controller 111 sets the image quality change flag to True when a scene change is detected by the scene detector 116.

The controller 111 determines whether the image quality change flag is True (step S103). When the image quality change flag is not True (that is, False), the controller 111 obtains a negative determination result in step S103 and terminates the flowchart in FIG. 5 without changing the image quality parameters.

When the image quality change flag is True, the controller 111 obtains a positive determination result in step S103 and proceeds to step S104. The scene detector 116 determines whether a scene change has been detected (step S104). When the scene detector 116 has not detected a scene change, the controller 111 obtains a negative determination result in step S104 and terminates the flowchart in FIG. 5.

When the scene detector 116 detects a scene change, the controller 111 obtains a positive determination result in step S104 and proceeds to step S105. The controller 111 changes the image quality parameters applied to the image processor 113 to image quality parameters for the genre of the next program (the program B) obtained by the acquirer 114 (step S105).

The controller 111 sets the image quality change flag to False (step S106). Therefore, the image quality change flag is back to False. After the process in step S106, the controller 111 terminates the flowchart in FIG. 5. The processes in step S101 to step S106 are continuously executed while the video data of the program of the broadcast wave received by the receiver 102 is displayed on the display 106.

As described above, in this embodiment, the controller 111 changes the image quality parameters after a genre change is detected and after a scene change is detected, rather than only when a genre change is detected. Accordingly, image processing using the image quality parameters of the genre information of the next program is prevented from being performed on the video data of the program being displayed.

### Second Embodiment

Next, a second embodiment will be described. In the second embodiment, a controller 111 controls an image processor 113 to perform smoothing processing after a scene change is detected. The smoothing process is a process of changing image quality in stages.

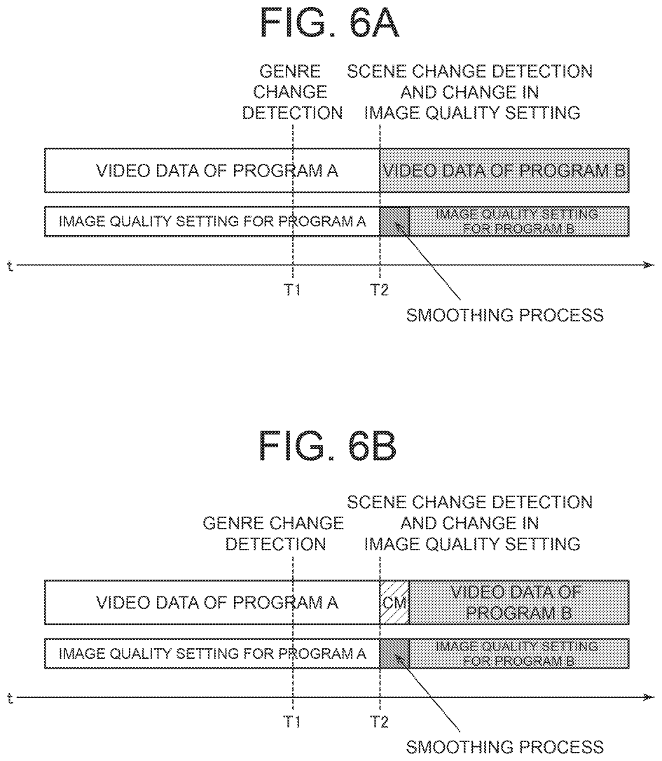

FIG. 6A is a diagram illustrating an example of a change in an image quality setting to which the second embodiment is applied. The controller 111 acquires video feature values of video data at a time point T2 when a scene change is detected and changes image quality parameters in stages to image quality parameters for genre information of a next program B, starting from image quality parameters corresponding to the video feature values. The controller 111 may change image quality parameters to be applied to the same program depending on a scene. For example, in the example in FIG. 6A, the controller 111 performs control such that image processing is performed using image quality parameters for a program A until the time point T2.

On the other hand, video data of the program A includes a plurality of scenes (frames), and the different scenes have different video feature values. The controller 111 analyzes the video feature values of the individual scenes included in the video data and changes the image quality parameters corresponding to genre information of the program A in accordance with the video feature values of the individual scenes. The image quality parameters (image quality parameters for the image processing to be performed on the video data of the program A) are changed according to the scenes, and therefore, image quality of the video data may be improved. This is also true for the other embodiments.

When changing the image quality parameters, the controller 111 sets image quality parameters corresponding to video feature values of a scene in the video data, instead of at the time point T1, at the time point T2 when a scene change is detected. Then the controller 111 performs a process (a smoothing process) of changing the image quality parameters in stages to the image quality parameters for the program B from the image quality parameters employed at the time point T2.

At the time point T2, when the image quality parameters applied to the image processor 113 are directly changed from the image quality parameters for the program A to the image quality parameters for the program B, the image processing applied by the image processor 113 to the video data immediately changes. Therefore, a video displayed on the display 106 is suddenly changed, resulting in degradation of visibility of a user.

At the time point T2, the controller 111 causes the image processor 113 to perform the smoothing process described above. As a result, the image quality parameters are changed in stages from the time point T2, and therefore, the image processing applied to the video data by the image processor 113 gradually changes. Therefore, the video displayed on the display 106 can also gradually changes.

Any method, such as linear interpolation, can be employed as the smoothing process. The controller 111 may keep a degree of the change in stages of the image quality parameters constant or different when the smoothing process is performed. For example, the controller 111 may gradually increase a degree of the change in the image quality parameters while performing the smoothing process.

FIG. 6B is a diagram illustrating an example of a change in an image quality setting to which the second embodiment is applied. At the time point T2, the broadcast wave switches from the program A to a CM. Here, the scene detector 116 detects a scene change. The controller 111 performs the smoothing process after the scene detector 116 detects a scene change.

Then the controller 111 performs the smoothing process of changing the image quality parameters to be applied to the image processor 113 in stages from the image quality parameters for the program A to the image quality parameters for the program B, starting from the time point T2. By this, the video displayed on the display 106 can also gradually changes.

A duration of one CM is defined as a certain specified period of time (for example, 15 seconds). Then the controller 111 may perform the smoothing process such that the image quality parameters for the program A are changed to the image quality parameters for the program B in stages during the specified time of the CM.

As described in the first embodiment, the scene detector 116 can detect a switch from a broadcast program to a CM based on audio data or a logo mark, for example. When the scene detector 116 detects a switch to the CM, the controller 111 may change the image quality parameters in stages at equal intervals (for example, 1 second) for the specified time of the CM.

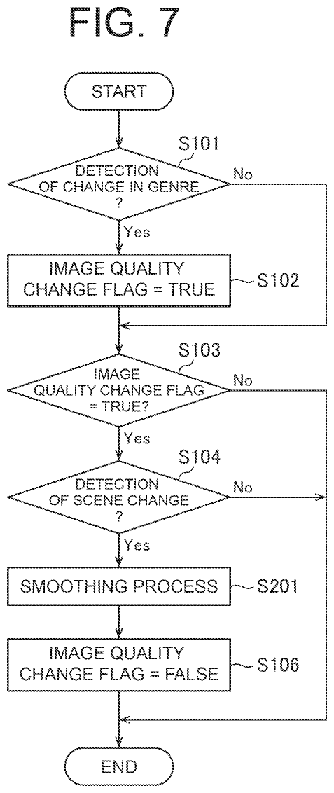

FIG. 7 is a flowchart of an example of the process according to the second embodiment. Since individual processes from step S101 to step S106 are the same as those in the first embodiment, descriptions thereof are omitted. The controller 111 performs the smoothing process after the scene detector 116 detects a scene change (step S201). In this way, after a scene change is detected, the image quality parameters employed in the image processor 113 are changed in stages.

As described above, in this embodiment, the controller 111 performs the smoothing process of gradually changing the image quality parameters that are employed at the time point T2 to the image quality parameters of the next program after the scene change is detected.

As a result, the image quality parameters employed in the image processor 113 when the image processor 113 performs the image processing on the image data are changed in stages, and therefore, image quality of the video data is also changed in stages. Compared to the case where the image quality parameters employed in the image processor 113 are immediately changed, the discomfort caused to the user can be reduced.

### Third Embodiment

Next, a third embodiment will be described. As described above, the controller 111 changes the image quality parameters to be employed when the image processor 113 performs the image processing on the video data after a genre change is detected and after a scene change is detected. Here, the scene detector 116 may not detect a scene change after the genre detector 112 detects a change in genre information.

For example, when a sum of differences between absolute values of individual bins of a brightness histogram of last video data of the program A and absolute values of individual bins of a brightness histogram of first video data of the program B is less than the threshold value described above, the scene detector 116 does not detect a scene change.

In the third embodiment, when the scene detector 116 does not detect a scene change even after a predetermined period of time TW has elapsed since the genre detector 112 detected a change in genre information, the controller 111 determines that a time-out has occurred and performs the smoothing process described in the second embodiment. The predetermined period of time TW may be set, for example, as a specified period of time for one CM (for example, 15 seconds). The predetermined period of time TW may be set, for example, as an arbitrary period of time other than the specified period of time for one CM.

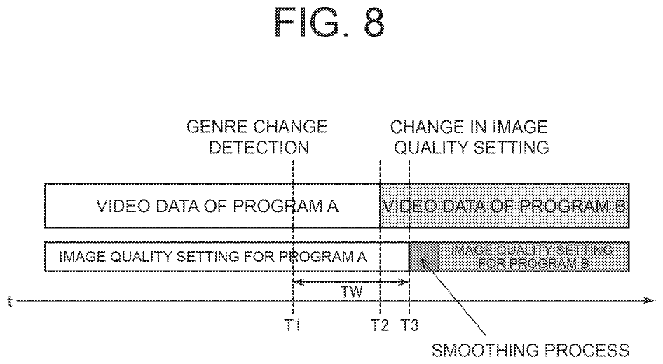

FIG. 8 is a diagram illustrating an example of a change in an image quality setting to which the third embodiment is applied. As illustrated in the example of FIG. 8, at a time point T1, the genre detector 112 detects a change in genre information. On the other hand, at a time point T2 when the video data of the program A is switched to the video data of the program B, the scene detector 116 does not detect a scene change. In this case, the controller 111 starts the smoothing process at a time point T3 after the predetermined period of time TW has elapsed from the time point T1.

This prevents the image quality parameters from not being changed when the scene detector 116 does not detect a scene change due to a small difference in the bright histograms of the video data.

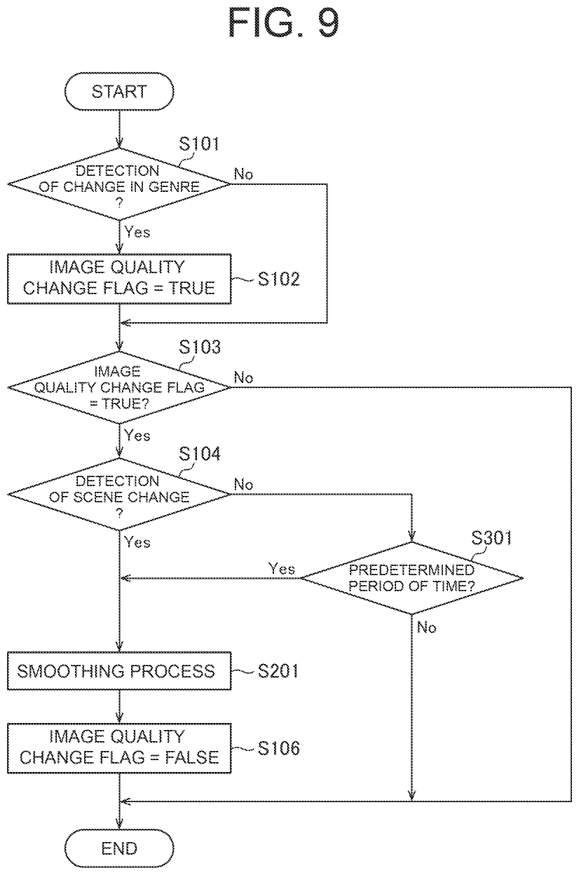

FIG. 9 is a flowchart of an example of the process according to the third embodiment. Since individual processes from step S101 to step S106 and a process in step S201 are the same as those in the second embodiment, descriptions thereof are omitted.

The controller 111 obtains a negative determination result in step S104 when the scene detector 116 does not detect a scene change and determines whether the predetermined period of time TW has elapsed after the change of genre information is detected (step S301).

When the predetermined period of time TW has not elapsed after the change in genre information is detected, the controller 111 obtains a negative determination result in step S301 and terminates the flowchart in FIG. 9. In this case, the processes in the flowchart of FIG. 9 are continuously executed while video data of a program of a broadcast wave received by the receiver 102 is displayed on the display 106.

When the predetermined period of time TW has elapsed after the change in genre information is detected, the controller 111 obtains a positive determination result in step S301 and proceeds to step S201. Specifically, the controller 111 determines that a time-out has occurred and performs the smoothing process in step S201.

As described above, in this embodiment, when the scene detector 116 does not detect a scene change, the smoothing process is performed after the predetermined period of time TW has elapsed since the change in genre information is detected. Accordingly, the image quality parameters applied to the image processor 113 may be changed even when the scene detector 116 does not detect a scene change.

This embodiment may be applied to the first embodiment. In this case, the controller 111 performs the process in step S105 in the flowchart of FIG. 5 instead of the process in step S201 in the flowchart of FIG. 9. In this case, the controller 111 immediately performs switching of the image quality parameters, instead of the smoothing process, after the predetermined period of time TW has elapsed since the change in genre information is detected. Also in this case, the same effect as in this embodiment may be obtained.

Furthermore, the controller 111 may also vary a speed of the smoothing process depending on whether a time-out has occurred. Specifically, the controller 111 may set a processing speed of the smoothing process performed due to the occurrence of a time-out to be slower than a processing speed of the smoothing process performed due to the detection of a scene change performed by the scene detector 116.

As shown in the example in FIG. 8, at the time point T3 that comes after the predetermined period of time TW has elapsed from the time point T1, it is assumed that time has passed after the display of the video of the program B on the display 106 is started. It is preferable that a change in the image quality setting in the middle of the display of the video of the program B on the display 106 is gradually performed. Therefore, the controller 111 sets a slower processing speed for the smoothing process performed due to the occurrence of a time-out.

Furthermore, the controller 111 may perform the smoothing process when a time-out has occurred, and perform the process in step S105 of the first embodiment when the scene detector 116 detects a scene change. By this, a determination as to whether the smoothing process is to be applied may be controlled depending on whether a time-out has occurred.

### Fourth Embodiment

Next, a fourth embodiment will be described. A broadcast wave received by a receiver 102 includes program information about a program. A controller 111 generates an electronic programming guide (EPG) based on the program information received by the receiver 102. The electronic program guide is generated by arranging programs in chronological order by channel (broadcaster). For example, the electronic programming guide includes information on individual programs distributed by individual broadcasters on a weekly basis.

The electronic programming guide includes information on time points of start and lengths of the programs. The controller 111 stores electronic programming guide in a storage 103, for example. The electronic programming guide may be obtained from an external server using a network interface 107 through the Internet.

Here, the controller 111 may set a time point at which the image quality parameters are changed based on the electronic programming guide. The electronic programming guide includes information on start time points of the programs and program lengths as described above. The controller 111 sets the time point at which the image quality parameters are changed based on the start time points of the programs included in the electronic programming guide. Note that, when the electronic programming guide includes information on end times of the programs, the controller 111 may recognize switches of the programs based on the end times of the programs included in the electronic programming guide.

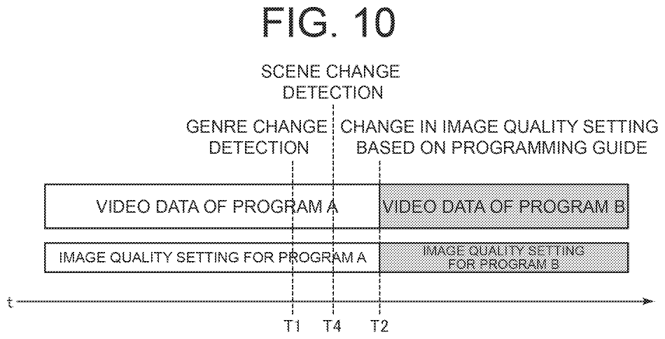

FIG. 10 is a diagram illustrating an example of a change in an image quality setting to which the fourth embodiment is applied. The programing guide data indicates that the program A is switched to the program B at a time point T2. On the other hand, a scene detector 116 may detect a scene change at a time point T4 before the time point T2.

The video data of the program A includes a plurality of scenes. Video feature values (e.g., brightness and hue histograms) of consecutive scenes in the scenes of the program A may significantly change from one to another. In this case, the scene detector 116 detects a scene change before switching from the program A to the program B.

In this embodiment, when the programming guide data is available, the controller 111 does not change the image quality parameters and performs control such that the image quality parameters of the program A are maintained even when the scene detector 116 detects a scene change. Then, based on the programming guide data, the controller 111 performs control such that the image quality parameters are changed after a current time matches the time point T2 at which the program A is switched to the program B.

Accordingly, even when the scene detector 116 detects a scene change before the program is switched, a time point at which the image quality parameters applied to the image processor 113 are changed may match a time point at which the video data is switched. In this case, image processing using image quality parameters for genre information of a next program is not performed on video data of a program being displayed, and therefore, image quality is not degraded.

Here, the programming guide data is different from genre information multiplexed in a broadcast wave. When the programming guide data is used, the controller 111 executes a predetermined application to read and decode the programming guide data stored in the storage 103, for example.

Therefore, the controller 111 is required to perform image processing on video data and a process associated with the programming guide data in real time based on a broadcast wave received by the receiver 102, and accordingly, processing efficiency is degraded. In other words, when the controller 111 performs the various processes described above, it is more efficient to perform the processes in real time based on the genre information included in the distributed programming guide data than the processes using the programming guide data. Therefore, a setting of a process using the programming guide data or a setting of a process without the programming guide data may be selected, for example. For example, the user may select one of the above settings on a television receiver 100 using a remote controller. Furthermore, when the television receiver 100 is shipped, the process using the programming guide data or the process without the programming guide data may be set.

When the programming guide data is not used, the controller 111 performs such control that the image quality parameters are changed after the genre detector 112 detects the change in genre information and after the scene detector 116 detects a scene change.

As described above, according to the fourth embodiment, since the controller 111 performs control such that the image quality parameters are changed using the programming guide data, the image processing using image quality parameters of genre information for a next program is prevented from being performed on video data of a program being displayed. As a result, degradation of image quality can be suppressed. The fourth embodiment may be applied to the first to third embodiments.

### Fifth Embodiment

Next, a fifth embodiment will be described. Program data of a broadcast wave received by a receiver 102 can be recorded on an external recording device 121. For example, when a user operates a remote controller to issue a recording instruction, a remote control signal receiver 108 receives the recording instruction from the remote controller. In response to the recording instruction, a controller 111 records program data (recording data) in the external recording device 121. When a function, such as reserved recording, is used, the controller 111 records specified program data at a specified time in the external recording device 121.

The program data is recorded in the external recording device 121 in a format known as partial TS (Transport Stream), for example. The partial TS is a group of packets constituted by packets required for reproduction of program data selected from among TS packets of a normal broadcast wave.

The program data recorded on the external recording device 121 in the form of the partial TS also includes genre information in the same way as the broadcast wave received by the receiver 102. The genre information is not synchronized with video data of the program data. Furthermore, a timing of a change in genre information precedes a timing of switching of video data. Therefore, when image quality parameters are changed to those of a next program at the timing when the change in genre information is detected, the problem described above occurs.

It is assumed that a user operates a remote controller to reproduce program data recorded on the external recording device 121. The remote controller transmits an instruction for reproducing the specified program data. The remote control signal receiver 108 receives the reproduction instruction. The remote control signal receiver 108 outputs the received reproduction instruction to a processor 101.

A reproducer 115 reads the specified program data from the external recording device 121 via a connector 104 in response to the reproduction instruction. In this case, the connector 104 functions as a receiver. The reproducer 115 then controls reproduction of the read program data. The reproducer 115 causes a display 106 to display a video of the program data and a speaker 105 to output audio of the program data.

While the reproducer 115 controls the reproduction of the program data, the controller 111 performs the control according to the first embodiment described above. Specifically, the controller 111 performs the various processes in the flowchart in FIG. 5.

As described above, the program data recorded on the external recording device 121 includes video data and genre information. Furthermore, the video data is not synchronized with the genre information. Therefore, the controller 111 determines whether the genre detector 112 has detected a change in genre information while the reproducer 115 reproduces the program data.

The controller 111 does not change the image quality parameters until the genre detector 112 detects a change in genre information and the scene detector 116 detects a scene change. The controller 111 changes the image quality parameters to be applied to the image processor 113 to the image quality parameters for the next program after the genre detector 112 detects a change in genre information and after the scene detector 116 detects a scene change.

As described above, the same effect as in the first embodiment can be obtained when program data recorded on the external recording device 121 is reproduced. The fifth embodiment may be applied to the first to fourth embodiments.

### Sixth Embodiment

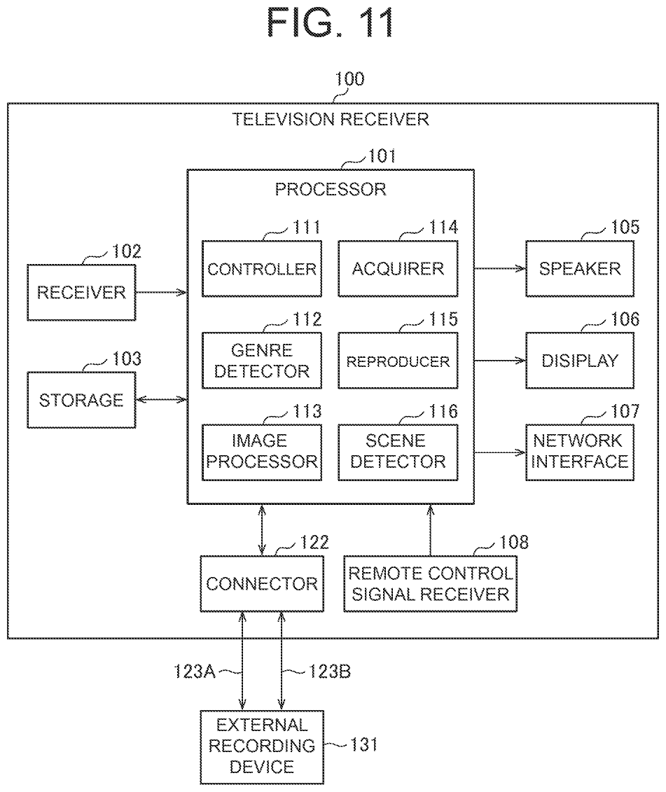

Next, a sixth embodiment will be described. FIG. 11 is a diagram illustrating an example of a television receiver 100 according to a sixth embodiment. In the example in FIG. 11, an external recording device 131 is connected to the television receiver 100. The external recording device 131 in the example of FIG. 11 is different from the external recording device 121 in the example of FIG. 1.

The external recording device 131 in the example of FIG. 11 is a recorder capable of performing writing and reading on optical discs, such as a Blu-ray (registered trademark) recorder. The external recording device 131 and a connector 122 of the television receiver 100 are connected to each other by an HDMI (registered trademark) (High-Definition Multimedia Interface) cable, for example. Therefore, both the television receiver 100 and the external recording device 131 are HDMI-compatible devices.

The HDMI cable includes an AV signal transmission path 123A and a CEC (Consumer Electronics Control) signal transmission path 123B. The AV signal transmission path 123A is a first transmission path for transmitting video data and audio data. The CEC signal transmission path 123B is a second transmission path of a single-line serial defined in the HDMI-CEC standard. The television receiver 100 and the external recording device 131 may perform EDID (Extended Display Identification Data) aware communication with each other through the CEC signal transmission path 123B.

The controller 111 of the television receiver 100 performs control such that program data of a broadcast wave received by a receiver 102 is recorded on the external recording device 131 through the HDMI cable. By this, the program data of the broadcast wave received by the television receiver 100 is recorded as recording data on the external recording device 131.

In the sixth embodiment, as in the fifth embodiment, a reproducer 115 reads program data recorded on the external recording device 131 via the connector 122. In this case, the connector 122 functions as a receiver. The reproducer 115 controls reproduction of the program data. In the sixth embodiment, video data is transmitted via the AV signal transmission path 123A, and genre information is transmitted via the CEC signal transmission path 123B. The video data is not synchronized with the genre information.

Therefore, in the sixth embodiment, the same process as in the first embodiment is performed. The controller 111 changes the image quality parameters after the genre detector 112 detects a change in genre information and the scene detector 116 detects a scene change.

As described above, the same effect as in the first embodiment can be obtained when the program data recorded on the external recording device 131 is reproduced through the HDMI cable. The sixth embodiment may be applied to the first to fourth embodiments.

Modifications According to the fourth embodiment described above, program data of a broadcast wave received by the receiver 102 of the television receiver 100 is recorded on the external recording device 121. When the reproducer 115 reproduces program data recorded on the external recording device 121, the controller 111 performs the various processes described in the fourth embodiment.

For example, the fourth embodiment is also applicable when the program data recorded on the external recording device 121 is not program data of a broadcast wave but moving image data (content). The content is provided by an external server, for example, connected via the Internet. For example, the television receiver 100 obtains the content from the network interface 107 via the Internet, and the obtained content is recorded on the external recording device 121. Alternatively, the content may be recorded on the external recording device 121, for example, via a personal computer, without using the television receiver 100.

The content may include a plurality of moving image data. In this case, genre information may be included in the content for each moving image data. Furthermore, there may be a case where individual video data and corresponding genre information of moving image data are not synchronized with each other.

In such a case, when the reproducer 115 reproduces the plurality of moving image data included in the content, the controller 111 performs the various processes of the fifth embodiment so that the same effects as in the fifth embodiment are obtained. The same effects as in the sixth embodiment can be obtained by the controller 111 performing the various processes of the sixth embodiment even when the content is recorded on the external recording device 131 that is connected to the television receiver 100 via HDMI as in the sixth embodiment.

Furthermore, the content may be distributed by an external server, for example. For example, the television receiver 100 is connected using the network interface 107 to an external server via the Internet. The television receiver 100 can perform streaming reproduction of content distributed by the external server.

When the content subjected to the streaming reproduction includes a plurality of moving image data and genre information is associated with the individual moving image data, the controller 111 can perform the various processes of the fifth or sixth embodiment described above. The content is obtained from the external server, instead of the external recording device 121 or the external recording device 131. In this case, the network interface 107 functions as a receiver.

The present disclosure is not limited to each of the above-described embodiments, and various modifications may be made thereto within the scope indicated by the claims. An embodiment that can be implemented by appropriately combining technical sections disclosed in the different embodiments also falls within the technical scope of the present disclosure. Furthermore, new technical features can be created by combining the technical sections disclosed in the embodiments. The order of the processes in the flowcharts described in the embodiments described above can be interchanged as much as possible.

The programs that realize the functions of the embodiments are stored in a non-transitory recording medium, such as a semiconductor medium, an optical recording medium, or a magneto-optical recording medium. For example, a non-volatile memory card or the like may be used as the semiconductor medium. A CD (Compact Dick) or a DVD (Digital Versatile Disk) may be used as the optical recording medium and the magneto-optical recording medium. Furthermore, the above program may be supplied to a computer via any transmission medium capable of performing transmission.

What is claimed is:

1. A display device comprising:
a receiver that receives at least video data and genre information;
an acquirer that acquires image quality information corresponding to the genre information;
a genre detector that detects a change in the genre information;
a scene detector that detects a scene change of the video data; and
a controller that performs, when a change in the genre information is detected, control such that image quality of the video data is set based on image quality information corresponding to the changed genre information after the change is detected and after the scene change is detected.

2. The display device according to claim 1, wherein the scene detector detects the scene change based on a change in a brightness histogram of individual scenes in the video data.

3. The display device according to claim 1, wherein the scene detector detects the scene change based on a change in audio data corresponding to the video data.

4. The display device according to claim 1, wherein the controller starts control for setting image quality of the video data when the scene change is not detected after a predetermined period of time has elapsed since a change in the genre information is detected.

5. The display device according to claim 1, wherein the controller performs a process of performing a change, in stages, on image quality information corresponding to a video feature value of a scene of the video data at a time point when the scene change is detected, to image quality information corresponding to the changed genre information.

6. The display device according to claim 5, wherein the controller starts the process of performing a change in stages when the scene change is not detected after a predetermined period of time has elapsed since a change in the genre information is detected.

7. The display device according to claim 6, wherein the controller sets a processing speed of the process of performing a change in stages when the scene change is not detected after the predetermined period of time has elapsed since a change in the genre information is detected to be slower than a processing speed of the process of performing a change in stages when a change in the genre information is detected.

8. The display device according to claim 6, wherein the controller performs control such that the process of performing a change in stages is performed when the scene change is not detected after the predetermined period of time has elapsed since a change in the genre information is detected and that the process of performing a change in stages is not performed when the scene change is detected before the predetermined period of time has elapsed since a change in the genre information is changed.

9. The display device according to claim 1, wherein the controller performs control such that a determination as to whether image quality of the video data is to be set based on programming guide data acquired by the display device.

10. The display device according to claim 9, wherein the controller performs control such that, when the programming guide data indicates that a time point at which the scene change is detected after the genre information is changed comes before program switching, image quality of the video data is set at a time point of the program switching.

11. The display device according to claim 1, further comprising:
a reproducer that reads and reproduces recording data of a program including the received video data and the received genre information, from a recording device that records the recording data, wherein
when a change in genre information of the recording data being reproduced is detected, the controller performs control such that image quality of the video data is set based on image quality information corresponding to the changed genre information after the change is detected and after the scene change is detected.

12. The display device according to claim 1, further comprising:
a reproducer that reads, from a recording device that records recording data of a program including the video data and the genre information, the video data being out of the recording data through a first transmission path, reads the genre information in the recording data through a second transmission path that is different from the first transmission path, and reproduces the recording data, wherein
when a change in genre information of the recording data being reproduced is detected, the controller performs control such that image quality of the video data is set based on image quality information corresponding to the changed genre information after the change is detected and after the scene change is detected.

13. A display control method that causes a computer to execute:
receiving at least video data and genre information;
acquiring image quality information corresponding to the genre information;
detecting a change in the genre information;
detecting a scene change of the video data; and
performing, when a change in the genre information is detected, control such that image quality of the video data is set based on image quality information corresponding to the changed genre information after the change is detected and after the scene change is detected.

14. A non-transitory computer readable recording medium recording a program that causes a computer to execute:
receiving at least video data and genre information;
acquiring image quality information corresponding to the genre information;
detecting a change in the genre information;
detecting a scene change of the video data; and
performing, when a change in the genre information is detected, control such that image quality of the video data is set based on image quality information corresponding to the changed genre information after the change is detected and after the scene change is detected.
